(19) United States
(12) Patent Application Publication
(10) Pub. No.: US 2003/0214107 A1
(43) Pub. Date: Nov. 20, 2003

(54) Room service table handle

(76) Inventor: Jesus Antonio Fernandez, Naples, FL (US)

Correspondence Address: Edward M. Livingston, Esq., 628 Ellen Dr., P.O. Box 1599, Winter Park, FL, 32790, US

(21) Appl. No.: 10/151,216

(22) Filed: May 16, 2002

(51) Int. Cl. B62B 3/00

(52) U.S. Cl. 280/47.371

(57) ABSTRACT

A room-service table handle has a handle rod extendable rearwardly and upwardly intermediate a handle base (2) that is attached to an end of a wheeled room-service table (1) and a handlebar (3) that is fixable selectively for grasping by a user in a desirably upright body position. The room-service table is maneuverable at the handlebar with Class I Leverage being applied on back wheels (29) and Class II Leverage being applied on front wheels (28) while steering it in accordance with wheeling structure and while pushing or pulling selectively for intended room-service moving and positioning. The handle rod can be adjustable upwardly, downwardly and laterally from the room-service table. Optionally, the handle base is attached to the room-service table with either (1) a quick-release attachment that allows quick attachment to and quick detachment from the room-service table or with (2) a fixedly pivotal attachment that allows quick positioning of the room-service table handle upwardly for use and quick positioning of the table-service handle downwardly for non-use predeterminedly below and under a tabletop (9).

### BACKGROUND OF THE INVENTION

This invention relates to a room-service table handle for maneuvering a wheeled room-service table or cart to rooms in hotels, motels, hospitals and other accommodation facilities for providing room service with food, drinks, medicine and other room-service items.

Room-service tables on wheels are generally lower than normal waist height in order for their tabletops to position food, drinks, medicine and other room-service items for easy access from bedside beds, cushioned chairs, sofas, wheelchairs and standard chairs. The low height of the room-service carts and tables requires room-service personnel to bend down to reach and to maneuver them through hallways, in-and-out of elevators, through doorways and precisely where room occupants want them. For mostly aesthetic cart-appearance reasons, wheels of the room-service carts and tables are often small, nearly always inadequate for ease of maneuvering and quite heavy in weight, especially with the addition of the room-service items. To prevent spilling and jarring of the room-service items, special care in maneuvering is necessary. Careful handling often involves the room-service personnel placing their hands too close to the food to assure sanitation. All of these factors combined cause heavy physical and mental strain. The physical strain frequently results in back and other bodily injuries. The mental strain induces psychological conditions that tend to lower employee morale. For these reasons, a room-service table handle for maneuvering the room-service carts and tables has been provided by this invention.

There are different known types of handles for different types of mobile items that include bicycles and tricycles, but no known room-service table handles that are attachable adjustably and removably to a room-service cart or table for convenient, safe and easy handling in a manner taught by this invention.

Examples of most-closely related known but different devices are described in the following patent documents:

| U.S. Pat. No. | Inventor | Issue Date |
|---|---|---|
| 5,217,240 | Gardenhour, Jr., et al. | Jun. 08, 1993 |
| 5,558,348 | Becka | Sep. 24, 1996 |
| 5,306,030 | Becka | Apr. 26, 1994 |
| 4,872,697 | Berkowitz | Oct. 10, 1989 |
| 6,135,479 | Tibay, et al. | Oct. 24, 2000 |
| 6,149,178 | Bradbury, et al. | Nov. 21, 2000 |
| 4,445,704 | Troxler | May 01, 1984 |
| 5,028,066 | Garth | Jul. 02, 1991 |

### SUMMARY OF THE INVENTION

Objects of patentable novelty and utility taught by this invention are to provide a room-service table handle which:

has height adjustment for being positioned where it can be grasped by differing heights of room-service personnel in an upright body condition;

is positioned predeterminedly aft of room-service tables or carts to provide Class I Leverage being applied for lifting front wheels and Class II Leverage being applied for lifting rear wheels of room-service tables or carts;

is easily removable from interference with use of the tabletops and access to items on them; and

has firmness of attachment for reliable maneuvering of the room-service tables.

This invention accomplishes these and other objectives with a room-service table handle having a handle rod extendable rearwardly and upwardly intermediate a handle base that is attached to an end of a wheeled room-service table and a hand-grip handlebar that is fixable selectively for grasping by a user in a desirably upright body position. The room-service table is maneuverable at the hand-grip handlebar with Class I Leverage being applied on rear wheels and Class II Leverage being applied on front wheels of the room-service table while steering it in accordance with its wheeling structure and while pushing or pulling it selectively for intended room-service moving and positioning. The handle rod can be adjustable upwardly, downwardly and laterally from the room-service table. Optionally, the handle base is attached to the room-service table with either (1) a quick-release attachment that allows quick attachment to and quick detachment from the room-service table or with (2) a fixedly pivotal attachment that allows quick positioning of the table-service handle upwardly for use and quick positioning of the table-service handle downwardly for non-use predeterminedly below and under a tabletop.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a side elevation view of a room-service table handle attached to a room-service table with a vice-grip clamp;

FIG. 2 is a top view of the FIG. 1 illustration;

FIG. 3 is a side elevation view of a room-service table handle attached to a room-service table with a top clamp jaw and a bottom clamp jaw;

FIG. 4 is a side elevation view of a room-service table handle in position for attachment to a room-service table with a handle base that fits into a base receptacle on the room-service table;

FIG. 5 is a side elevation view of a room-service table handle attached to a room-service table with a handle base that fits onto a handle-attachment base on the room-service table;

FIG. 6 is a section view of the handle-attachment base and the handle base of FIG. 5 in assembly positioning as seen from section line 5-5 of FIG. 5;

FIG. 7 is a side elevation view of a room-service table handle attached pivotally to the room-service table,

FIG. 8 is a side elevation view of a room-service table handle having a height-adjustment portion that is telescopic;

FIG. 9 is a side elevation view of a room-service table handle having a height-adjustment portion with a height slide;

FIG. 10 is a top view of the room-service table handle with a D-shaped handle bar as an option to a T-shaped handle bar shown in FIG. 2;

FIG. 11 is a side elevation view of a non-adjustable embodiment with the vice-grip clamp for attachment to either standard or special room-service tables as represented by the room-service table with the unitary upright;

FIG. 12 is a fragmentary side view of the non-adjustable embodiment with the top clamp jaw and the bottom clamp jaw for attachment to room-service tables;

FIG. 13 is a fragmentary side view of the non-adjustable embodiment with the handle-base extension and the handle-base receptacle for attachment to room-service tables;

FIG. 14 is a fragmentary side view of the non-adjustable embodiment with the handle-attachment base and the handle-base extension for attachment to room-service tables; and

FIG. 15 is an elevation side view of the non-adjustable embodiment with the fixedly pivotal attachment member for attachment to room-service tables represented by the room-service table having the unitary upright inside of which an elevation spring has upward pressure on an elevation rod for ease of height adjustment of the tabletop.

### DESCRIPTION OF PREFERRED EMBODIMENT

Listed numerically below with reference to the drawings are terms used to describe features of this invention. These terms and numbers assigned to them designate the same features throughout this description.

```
  1. Room-service table
  2. Handle base
  3. Handlebar
  4. Maneuvering-leverage portion
  5. Height-adjustment portion
  6. Vice-grip clamp
  7. Base jaw
  8. Pivotal jaw
  9. Tabletop
10. Top clamp jaw
11. Bottom clamp jaw
12. Clamp fastener
13. Handle-base receptacle
14. Tapered portion
15. Receptacle fastener
16. Handle-attachment base
17. Handle-base extension
18. Handle-attachment fastener
19. Pivotal attachment member
20. Height-pivot member
21. Telescopic portion
22. Telescopic portion
23. Slidable portion
24. Height slide
25. T member
26. D member
27. Handlebar guides
28. Front wheels
29. Back wheels
30. Tabletop supports
31. Handle-rod base
32. Adjustment pins
33. Adjustment apertures
34. Unitary upright
35. Abutment member
36. Elevation rod
37. Base sleeve
38. Table base
39. Elevation spring
```

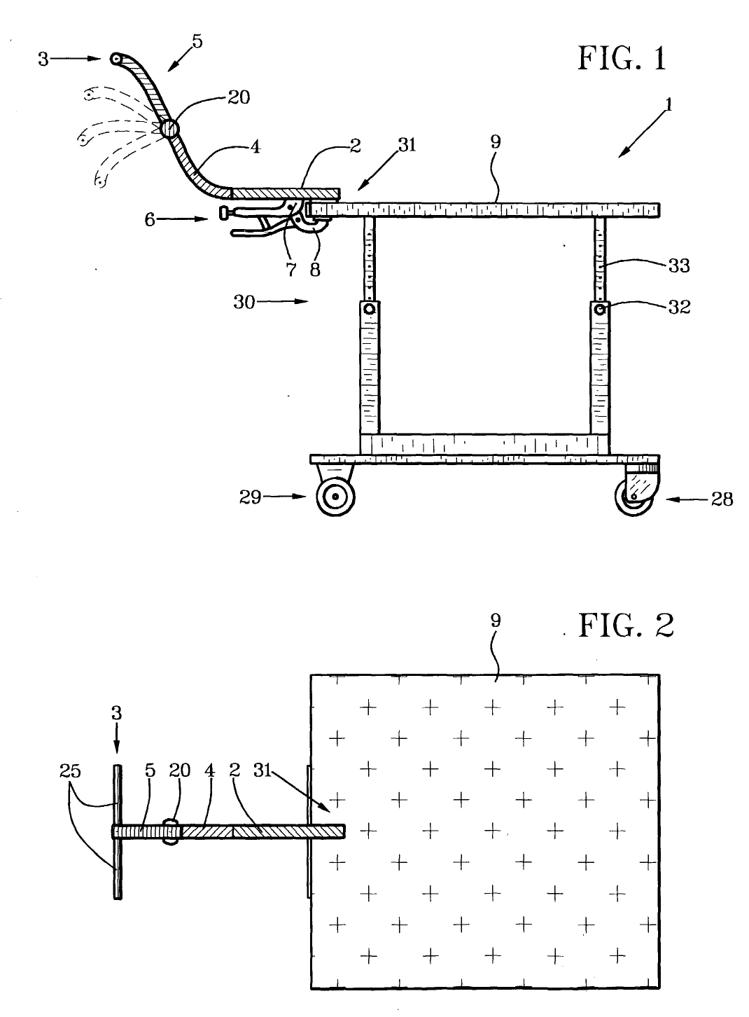

Referring to FIGS. 1-2, the room-service table handle has a handle rod that is articulated for positional maneuvering of a room-service table 1. The handle rod has a base end with a handle base 2 that is articulated to be attached predeterminedly to a maneuvering end of the room-service table 1. The handle rod has a handlebar end with a handlebar 3 that is oppositely disposed from the handle base 2. The handle rod has a maneuvering-leverage portion 4 extending in a predetermined direction outwardly from the maneuvering end of the room-service table 1. The handle rod can include a height-adjustment portion 5 extending predeterminedly upward from the maneuvering-leverage portion 4. The height-adjustment portion 5 is articulated for positioning the handlebar 3 upwardly and downwardly selectively by a user in proximate proportion to height of the user.

The handle base 2 can include a clamp with which the handle rod is attached detachably to the room-service table 1. The clamp can include a vice-grip clamp 6 having a base jaw 7 affixed to or predeterminedly combined with an underside of the handle base 2. The base jaw 7 and a pivotal jaw 8 of the vice-grip clamp 6 are articulated to clamp onto preferably a tabletop 9 of the room-service table 1.

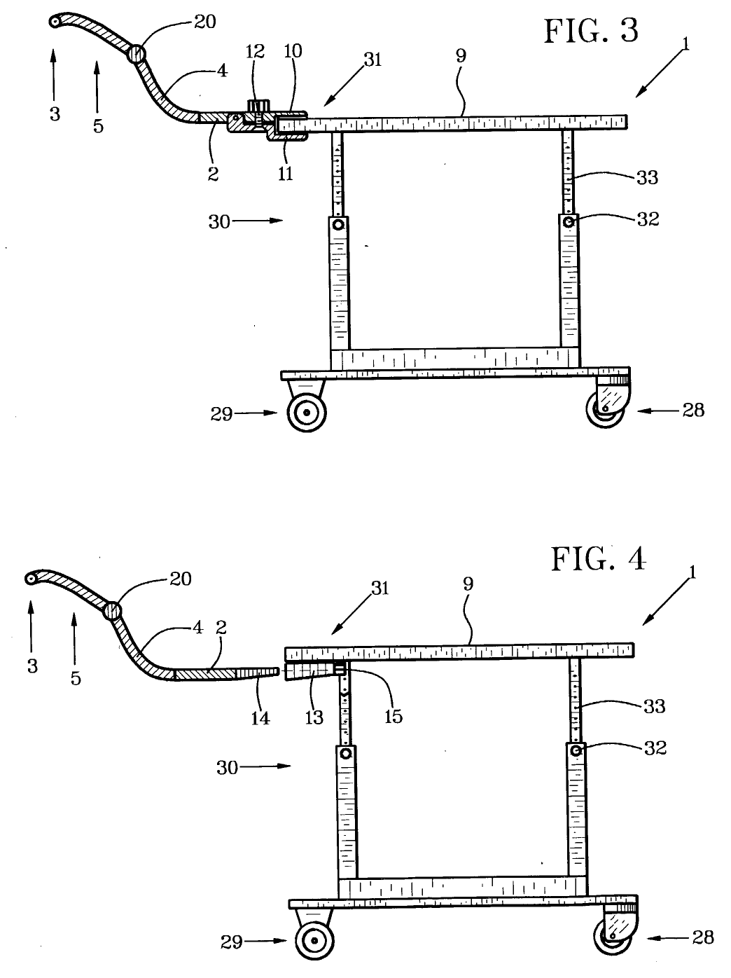

Referring to FIG. 3, the clamp can include a top clamp jaw 10 proximate the underside of the handle base 2 and a bottom clamp jaw 11 having a bottom-jaw extension vertically below the top clamp jaw 10. A clamp fastener 12 can be articulated to draw the bottom clamp jaw 11 towards the top clamp jaw 10 with a portion of preferably the tabletop 9 of the room-service table 1 inserted intermediate the top clamp jaw 10 and the bottom clamp jaw 11.

Referring to FIG. 4, the room-service table 1 can include a handle-base receptacle 13 into which the handle base 2 is articulated to fit predeterminedly. Preferably for tight fitting, the handle base 2 includes a tapered portion 14 that matches a tapered internal periphery of the handle-base receptacle 13 and a receptacle fastener 15 is articulated for fastening the tapered portion 14 of the handle base 2 in the handle-base receptacle 13.

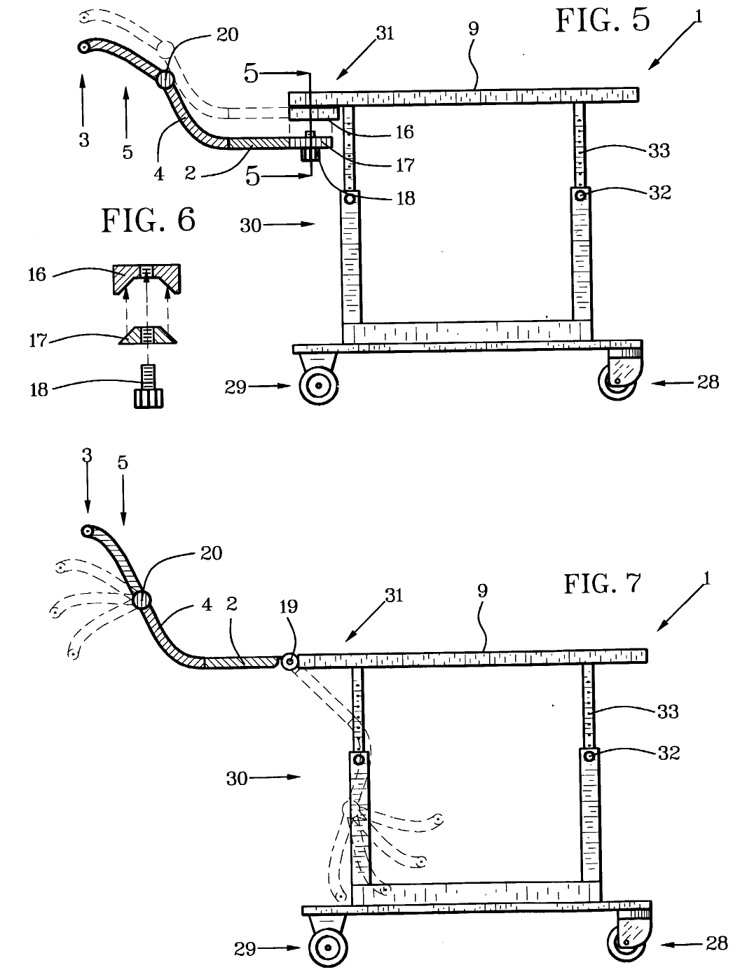

Referring to FIGS. 5-6, the room-service table 1 can include a handle-attachment base 16 onto which a handle-base extension 17 of the handle base 2 is articulated to fit. A handle-attachment fastener 18 is articulated for fastening the handle base 2 to the handle-attachment base 16. Preferably, the handle-attachment base 16 and the handle-base extension 17 have matching tapers as shown in FIG. 6.

Referring to FIG. 7, the room-service table 1 can include a fixedly pivotal attachment member 19 to which the handle base 2 can be articulated to be attached pivotally for fixedly pivotal attachment to the room-service table 1.

As shown in FIGS. 1, 3-5 and 7-9, the maneuvering-leverage portion 4 of the handle rod preferably includes an upwardly arched extension from the handle base 2.

As shown in FIGS. 1-5 and 7, the height-adjustment portion 5 of the handle rod can include a height-pivotal portion having a pivot end oppositely disposed from the handlebar 3 and attached pivotally to a height-pivot member 20 on the handle rod for fixedly pivotal adjustment of height of the handlebar in proportion to height of a user.

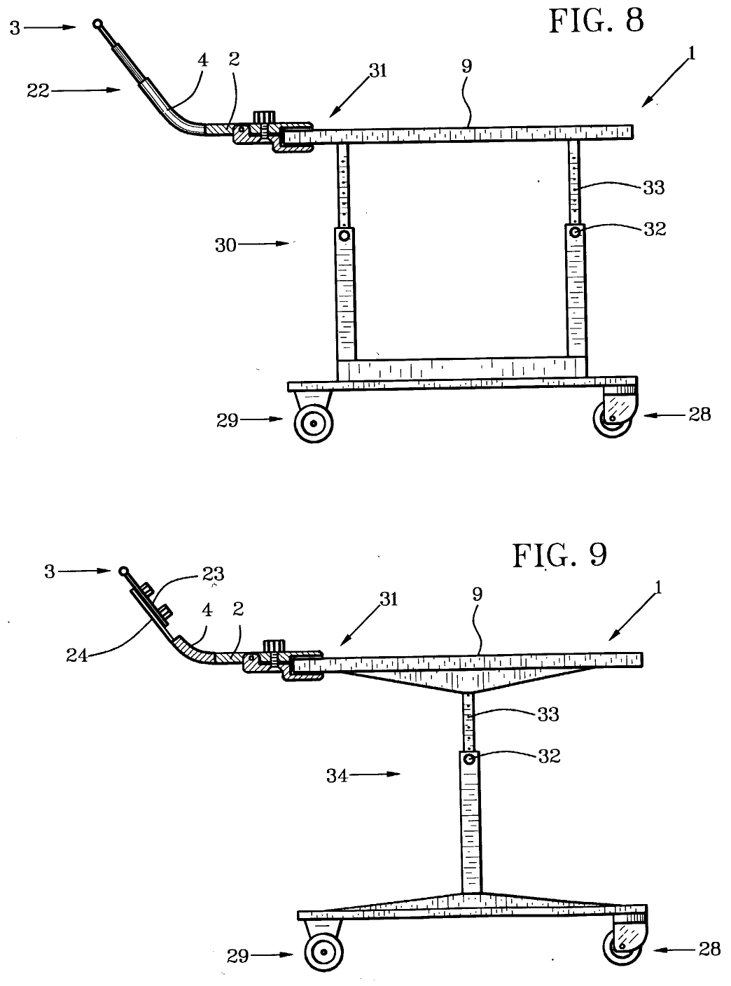

As shown in FIG. 8, the height-adjustment portion 5 of the handle rod can include a telescopic portion 22 with which vertical height of the handlebar 3 above the room-service tabletop 9 can be adjusted in proportion to height of a user.

As shown in FIG. 9, the height-adjustment portion 5 of the handle rod can include a slidable portion 23 that is slidable on a height slide 24 for slidable adjustment of height of the handlebar 3 above the tabletop 9 in proportion to height of a user.

As shown in FIG. 2, the handlebar 3 can include a “T” member 25 having handlebar-grip portions on opposite sides of the handlebar end of the handle rod.

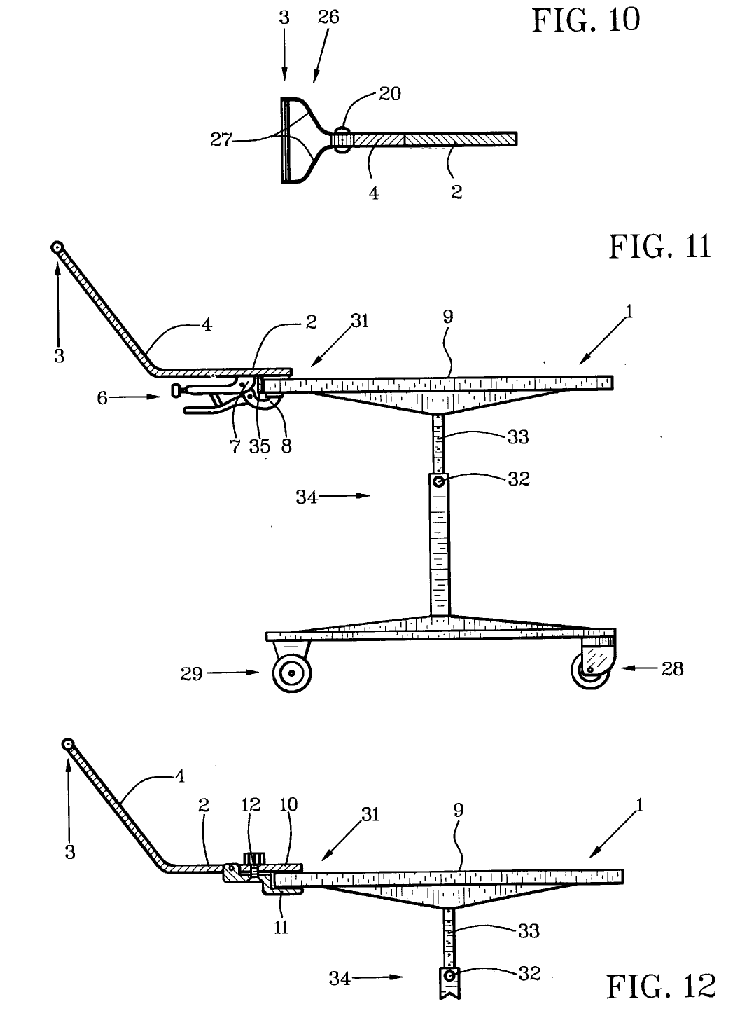

As shown in FIG. 10, the handlebar 3 can include a “D” member 26 having handlebar-grip portions intermediate handlebar guides 27 with which the “D” member is attached to the handle rod.

As depicted in FIGS. 1, 3-5, and 7-9, the room-service table 1 that can be articulated for this invention preferably has at least two front wheels 28 and at least two back wheels 29 on bottoms of tabletop supports 30 that support the tabletop 9. The room-service table 1 has a front end predeterminedly above the front wheels 28 and a back end predeterminedly above the back wheels 29. A handle-rod base 31 is proximate the back end of the room-service table 1. The handle base 2 and the handle-rod base 31 can be articulated for being fastened together predeterminedly for maneuvering the room-service table 1 with the room-service table handle. The handle-rod base 31 is preferably reinforced and can include the fixedly pivotal attachment member 19 to which the handle base can be attached pivotally.

The two front wheels 28 can include caster-pivotal attachment to the tabletop supports 30 for ease and reliability of maneuvering. The room-service table 1 is maneuverable at the handlebar 3 with Class I Leverage being applied downwardly on the back wheels 29 as a fulcrum for raising the front wheels 28 over obstacles. The room-service table 1 is maneuverable at the handlebar 3 with Class II Leverage being applied upwardly on the front wheels 28 as a fulcrum for raising the back wheels 29 over obstacles while steering and while pushing or pulling the room-service table 1 selectively with the handlebar 3 for intended room-service moving and positioning. Optional employment of Class I and Class II leveraging allows steering and maneuvering with all wheels being non-pivotal for special use conditions.

The tabletop supports 30 can be articulated for adjustment of height of the tabletop 9 above the front wheels 28 and the back wheels 29. Representative of a selection of foreseeable height adjusters are adjustment pins 32 in telescopically bottom portions of the tabletop supports 30 and adjustment apertures 33 in telescopically top portions of the tabletop supports 30. Optionally, as depicted in FIG. 9, the table-top supports 30 can include a unitary upright 34 or other foreseeable tabletop support 30.

Referring to FIGS. 11-15, the handle base 2 and the maneuvering-leverage portion 4 can be a single unit without height adjustment for some use conditions and preferences. It can be attachable to the room-service table 1, preferably onto the tabletop 9, the same as for any other embodiment of this room-service table handle.

For being attachable with a clamp, including the vice-grip clamp 6 as shown in FIG. 11 and as described in relation to FIG. 1, an abutment member 35 can be included protectively between the tabletop 9 and a pivotal joint of the base jaw 7 and the pivotal jaw 8.

As shown in FIG. 12, the maneuvering-leverage portion 4 that is the single unit without height adjustment can be attachable to the room-service table 1 with the top clamp jaw 10 and the bottom clamp jaw 11 described in relation to FIG. 3.

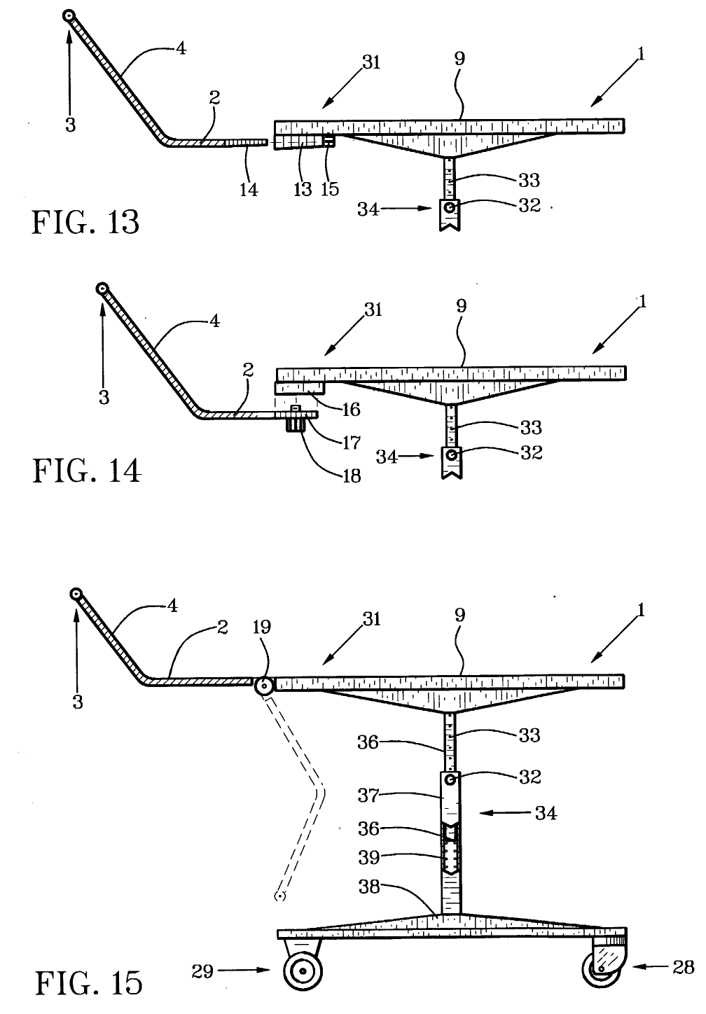

As shown in FIG. 13, the maneuvering-leverage portion 4 that is the single unit without height adjustment can be attachable to the room-service table 1 with the handle-base receptacle 13 and the tapered portion 14 described in relation to FIG. 4.

As shown in FIG. 14, the maneuvering-leverage portion 4 that is the single unit without height adjustment can be attachable to the room-service table 1 with the handle-attachment base 16 and the handle-base extension 17 described in relation to FIGS. 5-6.

As shown in FIG. 15, the maneuvering-leverage portion 4 that is the single unit without height adjustment can be attachable to the room-service table 1 with the fixedly pivotal attachment member 19 described in relation to FIG. 7.

As shown also in FIG. 15, the tabletop 9 to which the maneuvering-leverage portion 4 that is the single unit without height adjustment can be adjustable up-and-down vertically. Referring further to FIG. 15, the room-service table 1 can include the tabletop 9 proximate at least one tabletop support 30 that includes the unitary upright 34 on an elevation rod 36 that slides telescopically in a base sleeve 37 that is positioned uprightly on a table base 38 to which the front wheels 28 and the back wheels 29 are attached.

The tabletop support 30 and the unitary upright 34 can include a height adjuster for adjusting distance of the tabletop 9 above the table base 38 and for adjusting height of the handlebar 3 simultaneously. The height adjuster can include the elevation rod 36 that is slidable telescopically in a base sleeve 37 that is positioned uprightly on the table base 38. The adjustment pins 32 can include a selection of fastener members that are insertional in the adjustment apertures 33 that can include a selection of fastener apertures and indentations in the base sleeve 37 for locking the tabletop 9 at selected heights above the table base 38.

For aiding upward travel or lift of the tabletop 9 to a desired height for being height-locked selectively with the adjustment pin 32 or other height-locking member, the height adjuster can include an elevation spring 39 having expansion pressure intermediate the table base 38 and the elevation rod 36.

A new and useful room-service table handle having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A room-service table handle comprising:
a handle rod that is articulated for positional maneuvering of a room-service table;
the handle rod having a base end with a handle base that is articulated to be attached predeterminedly to a maneuvering end of the room-service table;
the handle rod having a handlebar end with a handlebar that is oppositely disposed from the handle base;
the handle rod having a leverage portion extending in a predetermined direction outwardly from the maneuvering end of the room-service table;
the handle rod having a height-adjustment portion extending predeterminedly upward from the maneuvering-leverage portion; and
the height-adjustment portion being articulated for positioning the handlebar upwardly and downwardly selectively by a user.

2. The room-service table handle of claim 1 wherein:
the handle base includes a clamp with which the handle rod is attached detachably to the room-service table.

3. The room-service table handle of claim 2 wherein:
the clamp includes a vice-grip clamp having a base jaw affixed to an underside of the handle base; and
the base jaw and a pivotal jaw of the vice-grip clamp are articulated to clamp onto the room-service table.

4. The room-service table handle of claim 2 wherein:
the clamp includes a top clamp jaw proximate the underside of the handle base and a bottom clamp jaw having a bottom-jaw extension vertically below the top clamp jaw;
the clamp includes a clamp fastener articulated to draw the bottom clamp towards the top clamp jaw with a portion of the room-service table inserted intermediate the top clamp jaw and the bottom clamp jaw.

5. The room-service table handle of claim 1 wherein:
the room-service table includes a handle-base receptacle; and
the handle base is articulated to fit predeterminedly in the handle-base receptacle.

6. The room-service table handle of claim 5 and further comprising:
a receptacle fastener that is articulated for fastening the handle base in the handle-base receptacle.

7. The room-service table handle of claim 1 and further comprising:
a handle-attachment base on the room-service table;
the handle base being articulated to fit onto the handle-attachment base; and
a handle-attachment fastener that is articulated for fastening the handle base to the handle-attachment base.

8. The room-service table handle of claim 1 wherein:
the handle base is articulated to be attached pivotally to the room-service table; and
the room-service table includes a fixedly pivotal attachment member to which the handle base is attached pivotally.

9. The room-service table handle of claim 1 wherein:
the maneuvering-leverage portion of the handle rod includes an upwardly arched extension from the handle base.

10. The room-service table handle of claim 1 wherein:
the height-adjustment portion of the handle rod includes a height-pivotal portion having a pivot end oppositely disposed from the handlebar and attached pivotally to a height-pivot member on the handle rod for fixedly pivotal adjustment of height of the handlebar in proportion to height of a user.

11. The room-service table handle of claim 1 wherein:
the height-adjustment portion of the handle rod includes a telescopic portion with which vertical height of the handlebar above the room-service table is adjustable telescopically in proportion to height of a user.

12. The room-service table handle of claim 1 wherein:
the height-adjustment portion of the handle rod includes a slidable portion that is slidable on a height slide on the handle rod for slidable adjustment of height of the handlebar in proportion to height of a user.

13. The room-service table handle of claim 1 wherein:
the handlebar includes a “T” member having handlebar-grip portions on opposite sides of the handlebar end of the handle rod.

14. The room-service table handle of claim 1 wherein:
the handlebar includes a “D” member having handlebar-grip portions positioned end-to-end intermediate handlebar guides with which the “D” member is attached to the handle rod.

15. The room-service table handle of claim 1 and further comprising:
a room-service table having at least two front wheels and at least two back wheels on bottoms of tabletop supports;
a tabletop on tops of the tabletop supports;
the room-service table having a front end predeterminedly above the front wheels and a back end predeterminedly above the back wheels;
a handle-rod base on the back end of the room-service table; and
the handle-rod base and the handle base being articulated for being fastened together predeterminedly for maneuvering the room-service table with the room-service table handle.

16. The room-service table handle of claim 15 wherein:
the back end of the tabletop includes the handle-rod base; and
the handle base is articulated for being fastened to the handle-rod base.

17. The room-service table handle of claim 16 wherein:
the handle-rod base includes a clamp section of the tabletop;
the clamp section of the tabletop is reinforced and articulated for supporting the clamp and the room-service table handle.

18. The room-service table handle of claim 16 wherein:
the handle-rod base includes the fixedly pivotal attachment member to which the handle base is attached pivotally.

19. The room-service table handle of claim 15 wherein:
at least the two front wheels include caster-pivotal attachment to the tabletop supports.

20. The room-service table handle of claim 15 wherein:
the room-service table is maneuverable at the handlebar with Class I Leverage being applied downwardly on the rear wheels as a fulcrum for raising the front wheels over obstacle; and
the room-service table is maneuverable at the handlebar with Class II Leverage being applied upwardly on the front wheels as a fulcrum for raising the back wheels over obstacles while steering the room-service table and while pushing or pulling the room-service table selectively with the handlebar for intended room-service moving and positioning.

21. The room-service table handle of claim 15 wherein:
the tabletop supports are articulated for adjustment of height of the tabletop above the front wheels and the back wheels.

22. A room-service table handle comprising:
a handle rod that is articulated for positional maneuvering of a room-service table;
the handle rod having a base end with a handle base that is articulated to be attached predeterminedly to a maneuvering end of the room-service table;
the handle rod having a handlebar end with a handlebar that is oppositely disposed from the handle base;
the handle rod having a leverage portion extending in a predetermined direction outwardly from the maneuvering end of the room-service table; and
the handle base includes a clamp with which the handle rod is attached detachably to the room-service table.

23. The room-service table handle of claim 22 wherein:
the clamp includes a vice-grip clamp having a base jaw affixed to an underside of the handle base; and
the base jaw and a pivotal jaw of the vice-grip clamp are articulated to clamp onto the room-service table.

24. The service-table handle of claim 23 and further comprising:
an abutment member positioned protectively between the tabletop and a pivotal joint of the base jaw and the pivotal jaw.

25. A room-service table handle comprising:
a handle rod that is articulated for positional maneuvering of a room-service table;
the handle rod having a base end with a handle base that is articulated to be attached predeterminedly to a maneuvering end of the room-service table;
the handle rod having a handlebar end with a handlebar that is oppositely disposed from the handle base;
the handle rod having a leverage portion extending in a predetermined direction outwardly and in a predetermined direction upwardly from the maneuvering end of the room-service table;
the room-service table includes the tabletop proximate a top of at least one tabletop support;
the room-service table includes the front wheels on a front of a table base and the back wheels on a front of the table base; and
the tabletop support includes a height adjuster for adjusting distance of the tabletop above the table base and for adjusting height of the handlebar.

26. The service-table handle of claim 25 wherein:
the height adjuster includes an elevation rod that is slidable telescopically in a base sleeve that is positioned uprightly.

27. The service-table handle of claim 26 wherein:
the height adjuster includes the adjustment pins that are insertional in the base sleeve and in the adjustment apertures in the elevation rod.

28. The service-table handle of claim 26 wherein:
the adjuster includes an elevation spring having expansion pressure intermediate the table base and the elevation rod for aiding upward travel of the tabletop to a desired height for being height-locked selectively.
